(19) United States
(12) Patent Application Publication
(10) Pub. No.: US 2006/0272176 A1
(43) Pub. Date: Dec. 7, 2006

(54) Drying devices

(75) Inventors: Jack Elliott, Brighton (GB); David Kenneth Elliott, Strood (GB)

Correspondence Address: MILLS & ONELLO LLP, ELEVEN BEACON STREET, SUITE 605, BOSTON, MA, 02108, US

(73) Assignee: Direct Air Dryers Limited

(21) Appl. No.: 10/542,001

(22) PCT Filed: Dec. 23, 2003
(86) PCT No.: PCT/GB03/05655

§ 371 Date: Jul. 17, 2006

(30) Foreign Application Priority Data
Jan. 14, 2003 (GB) 0300752.3
Feb. 28, 2003 (GB) 0304643.0

(51) Int. Cl. F26B 21/00; F26B 13/00

(52) U.S. Cl. 34/523; 34/611

(57) ABSTRACT

The invention provides a drying device for use in drying carpets, rugs after flooding or cleaning by a wet process. In addition, the drying device may be utilised for drying the fabric of dwelling, viz, the floors, walls, ceilings and under floor cavities after flooding. To these ends, the drying device, in one format is made up of opposed sheets (4, 6) of flexible material, e.g. plastic sheeting, co joined along peripheral edge portions (8, 10, 12, 14), one, or both, sheets being provided with a multiplicity of small apertures (24) over the whole, or substantially the whole area thereof The sheets (4, 6) are joined internally by apertured webs (18) extending along the drying device to form channels (20) between the sheets. Provision is made along the peripheral edge portions (8, 10, 12, 14) of the sheets (4, 6) to attach at least one air blower (26) and to attach further drying devices (2a, 2b) using a connector means (30, 38). The air blower(s) (26) may supply drying air at ambient temperature, or heated to approx. 85°, depending upon the drying requirements.

This invention is concerned with improvements in or relating to drying devices for use in drying out flooded dwellings and for drying carpets and the like artefacts after a cleaning process.

Devices for drying out flooded dwellings are well known and conventionally comprise the use of air blowers in combination with dehumidifiers.

However, where a dwelling is flooded it often takes several months of drying before the structure of the dwelling is habitable.

Conventional air blowers are configured to blow air at ambient temperature or above in more or less one direction; however, the blowers may be used in conjunction with ancillary equipment that is attached to a blower so that some measure of control may be exercised over the surface area treated by the air blower.

U.S. Pat. No. 5,813,139 discloses an arrangement for drying carpets, in which arrangement the nozzle of an air blower is placed under an edge portion of a carpet. One or more coiled rods are threaded through the carpet at spaced intervals to raise portions of the carpet above the floor thereby creating a cavity for the passage of air for effecting the drying thereof. While this method of drying a carpet may be successful some damage may be done to carpets of a less robust nature.

The disclosure of U.S. Pat. No. 4,145,821 teaches the use of an air blower in combination with a skirt of flexible material so that air is blown over the surface of a carpet covered by the skirt. Such an arrangement may be good for drying carpets but it not very versatile in use.

A carpet drying system is disclosed in U.S. Pat. No. 5,992,051, which system comprises the use of a metal housing having an inlet port for drying air from a compressor, the housing also being provided with a plurality of hollow needle elements depending therefrom. Air from the housing passes through the hollow needle elements and through the fibres of a carpet on which the housing is placed.

The housing of U.S. Pat. No. 5,992,051 is provided with means for mutual attachment of the housing to one or more like housings for treating a larger area of a carpet, and the system of U.S. Pat. No. 5,992,051, while being made up of one or more metal housings, requires a lot of strenuous effort in use and limits its application. Also the system can only be used on floor surfaces.

The present invention seeks to overcome or at least mitigate the drawbacks of the prior art drying systems.

Thus, the present invention conveniently provides a drying device comprising opposed sheets of flexible material cojoined along peripheral edge portions thereof wherein at least one of the sheets is provided with a multiplicity of small apertures over its whole surface area, or substantially so, the drying device also comprising connector means for the attachment of an air blower thereto, whereby, when the drying device is in use, air from an air blower is fed between said sheets and through said apertures to remove moisture from a surface to be dried.

Preferably, the opposed sheets of flexible material may be cojoined by webs extending therebetween to form longitudinal channels between said sheets.

Conveniently, the webs may be provided with perforations to facilitate, when in use, the even distribution of air from an air blower attached to the drying device.

The connector means may conveniently comprise edge portions of quick release material for effecting the ready attachment and detachment of an air blower thereto.

Preferably, the flexible material may be a synthetic waterproof material such as plastic.

In one arrangement provided by the present invention, the drying device may conveniently comprise support means, effective when the drying device is in use, to position the drying device adjacent a wall or a ceiling to be dried.

In a further arrangement provided by the present invention the drying device may comprise a connector for co-joining one drying device with another like drying device.

Conveniently, the connector may be provided by a collar of flexible material having quick release surface portions for ready attachment and detachment to and from each drying device.

Preferably, the opposed, flexible sheets may be rectangular in shape or substantially so.

The present invention also conveniently provides a method of drying a carpet after cleaning or after immersion in water comprising the steps of:
a) placing a drying device according to any one of last nine preceding paragraphs with a sheet having apertures therein overlying a carpet;
b) attaching an air blower to the drying device; and,
c) blowing air into the drying device and through the apertures to dry said carpet.

The present invention further conveniently provides a method of drying a dwelling after the ingress of water thereto comprising the steps of:
a) placing a drying device according to the last nine but one preceding paragraphs with a sheet, or sheets, having apertures therein against a surface, or between surfaces to be dried;
b) attaching an air blower to the drying device; and,
c) blowing air into the drying device and through the apertures in the sheet or sheets to dry said surface or surfaces.

The surface to be dried by the method of the last preceding paragraph may be:
a) a floor; or,
b) a wall; or,
c) a ceiling; or,
d) those surfaces bounding a closed space between floorboards and a concrete base or the like.

Preferably, in the method according to any one of the last three preceding paragraphs the air is heated to above ambient temperature; more preferably, the air is heated to over 85 degrees C.

There now follows by way of example of the present invention a detailed description of a drying device and its method of use, which description is to be read with reference to the accompanying drawings in which:

FIG. 1 is an underside plan view of a drying device;

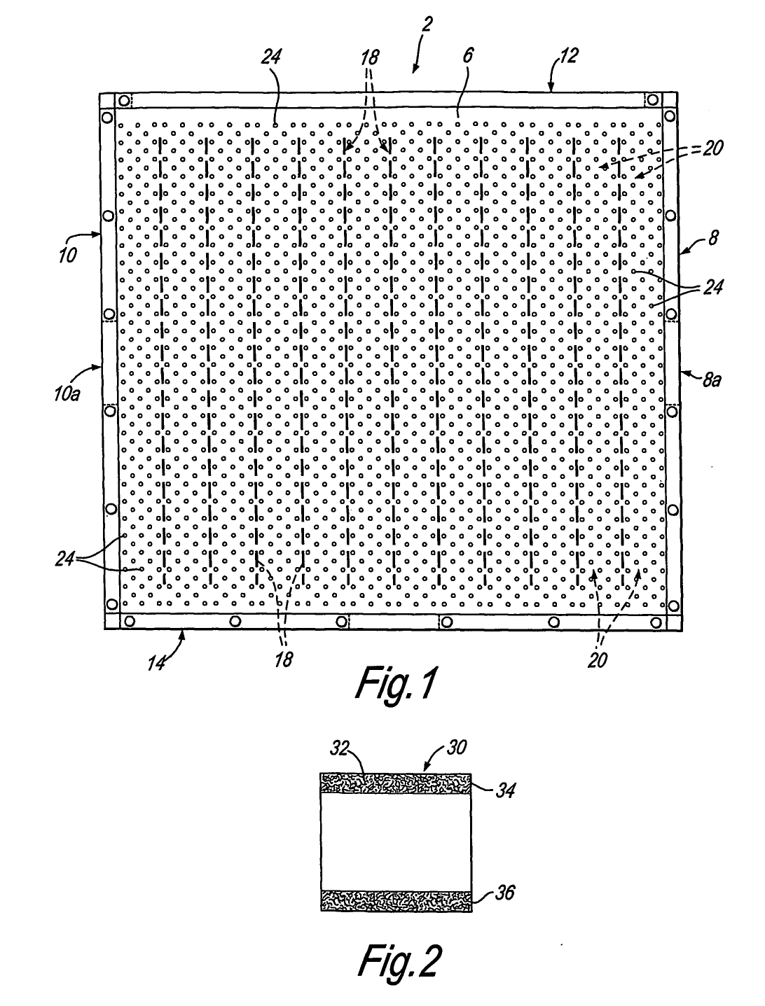

FIG. 2 is a plan view of a connector for use with the drying device of FIG. 1;

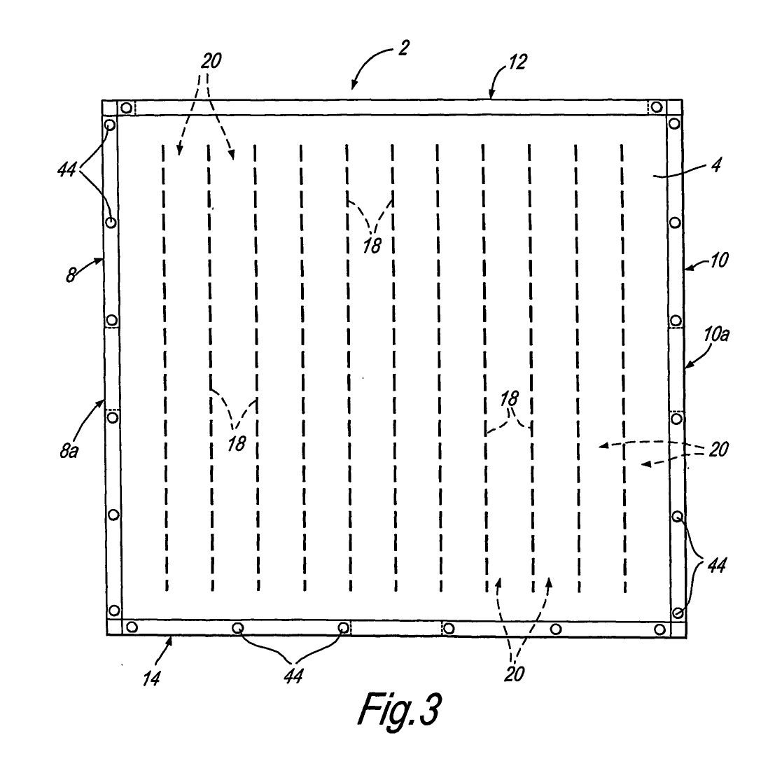

FIG. 3 is an upper plan view of the drying device of FIG. 1;

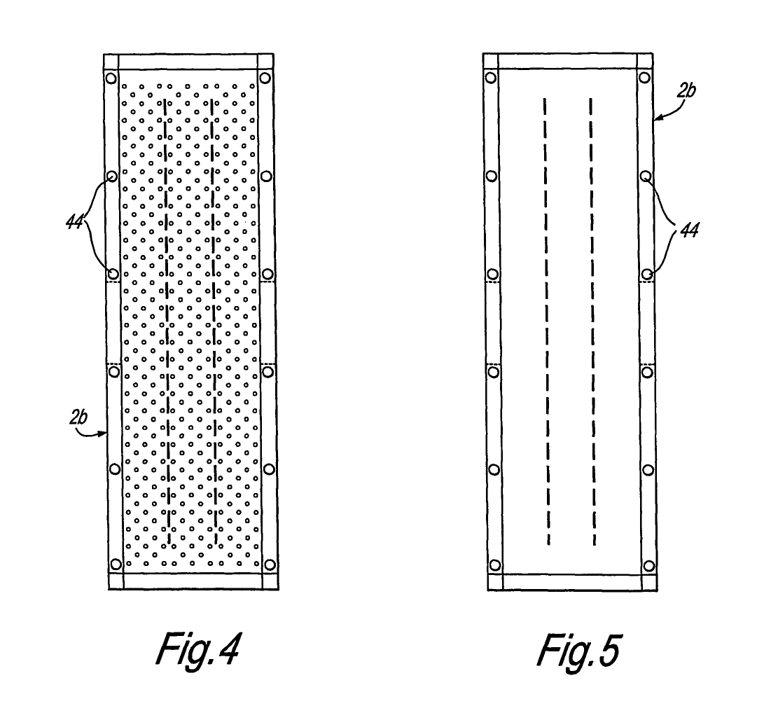

FIG. 4 is an underside plan view of a complementary drying device;

FIG. 5 is an upper plan view of the complementary drying device of FIG. 4;

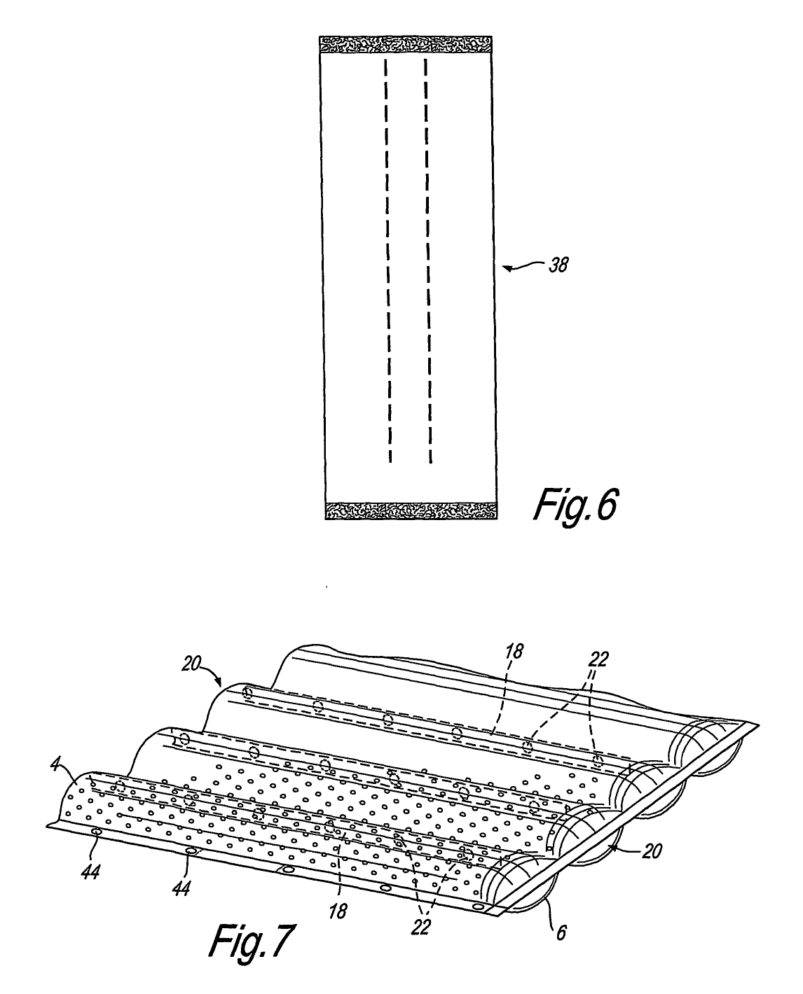

FIG. 6 is a plan view of another connector;

FIG. 7 is a diagrammatic upper perspective view showing a portion of an inflated drying device; and,

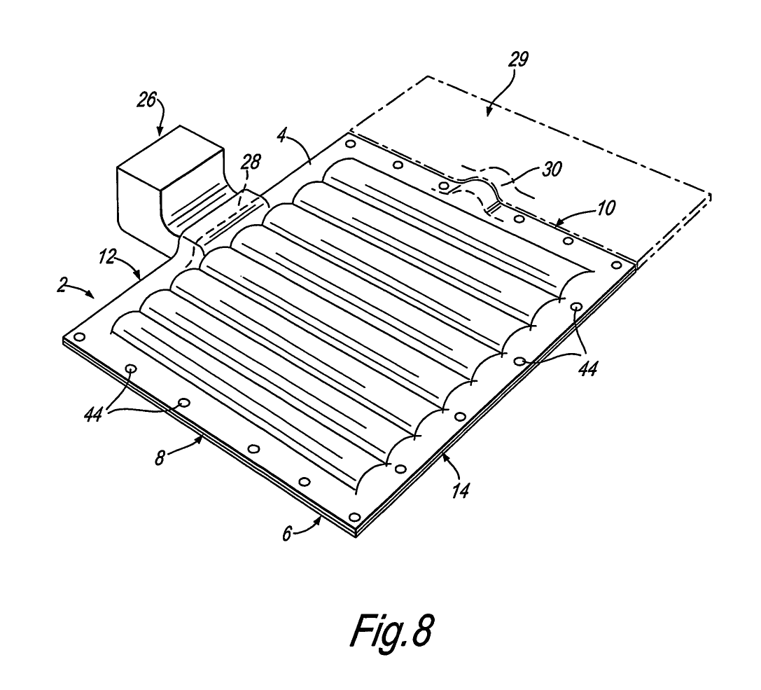

FIG. 8 is an upper perspective view of co-joined drying devices of the invention.

The drying device 2 of the present invention is intended for use in very many different applications including:
a) drying carpets, rugs and other similar floor coverings that have been immersed in water due to flooding;
b) drying carpets, rugs and other similar floor coverings that have been cleaned by a wet process; and,
c) drying the fabric of a dwelling, that is the floors, walls, ceilings, under-floor cavities and fittings.

As will be made clear hereinafter, the drying device 2 provides a diversity of uses compared with prior arrangements due to it's ease of use and the flexible nature of the materials used in it's construction.

Thus, the drying device 2 is not unlike an inflatable beach-bed in construction and comprises upper and lower sheets 4 and 6 of waterproof material, the sheets 4 and 6 being rectangular in plan view, see FIGS. 1, 2 and 8.

The sheets 4 and 6, which are of the same size, or substantially so, are co-joined along peripheral side edge portions 8 and 10 and along a top edge portion 12 and a lower edge portion 14, see FIG. 1, 2 and 8.

The side edge portions 8 and 10 and the lower edge portion 14 are permanently co-joined therealong except for respective mid-portions 8a, 10a and 14a, which are detachably co-joined by needle fabric, or the like, for a purpose to be described hereinafter.

The top edge portion 12 of the drying device 2 is also detachably co-joined by needle fabric, or the like, along the whole length thereof for a purpose to be made clear hereinafter.

The sheets 4 and 6 are also co-joined internally by eleven webs 18, see FIGS. 1,2 and 7, which webs 18 divide the space between the sheets 4 and 6 into twelve longitudinal channels 20.

The webs 18 are each provided with apertures 22 connecting the channels 20 for a purpose to be described.

The lower sheet 6 is provided with a multiplicity of small apertures 24 over its whole surface area, see FIG. 1, the purpose of which will be made clear hereinafter.

The drying device 2 is used in combination with a conventional air blower 26, see FIG. 8. Thus, after laying the drying device 2 overlying a carpet or floor area to be dried, an operative attaches an air blower 26 to the drying device 2 by peeling apart the detachably co-joined top edge portion 12 thereof and placing a nozzle 28 of the air blower 26 therebetween.

The nozzle 28 of the air blower 26 is provided with needle fabric, not shown, for engagement with the needle fabric of the drying device 2 whereby the air blower 26 may be readily attached and detached therefrom. The operative closes the top edge portion about the nozzle 28 and switches on the air blower 26.

Air, at ambient temperature, or at an elevated temperature, e.g. over 85 degrees C, is blown between the sheets 4 and 6 to expand the drying device to an extent defined by the webs 16, see FIG. 7. The air from the blower 26 passes along the channels 20 and therebetween by virtue of the apertures 22 so that an even distribution of the air is achieved throughout the whole of the drying device 2.

Once the drying device is expanded, as shown in FIG. 7, the air passes through the multiplicity of small apertures 24 to impinge upon the carpet or floor surface to be dried.

It has been found that the time for drying a carpet using the drying device 2 of the present invention is only a fraction of the time require when using air blowers alone or in combination with ancillary attachments proposed hitherto.

In addition, because the drying device 2 is of a flexible construction, it may be used in situations where the surfaces to be dried are not flat or are normally inaccessible.

In a first modification of the drying device of the present invention, the upper sheet 4 thereof may also be provided with a multiplicity of small apertures therein so that the drying device may be placed between two surfaces to be dried, for example, the modified drying device may be positioned in an under-floor cavity to dry a base layer of concrete and the floorboards positioned thereabove.

In a second modification of the drying device 2, a collar 30 having needle fabric portions 32, see FIG. 2, may be used to co-join a first drying device 2 with another like device 2a, see FIG. 8. This is achieved by peeling apart the mid-portion 10a of the side edge portion 10 and fitting a first end portion 34 of the collar 30 therebetween. Likewise, an opposite end portion 36 of the collar 30 is fitted between the side edge portion of an adjacent drying device 2a, see FIG. 8.

FIGS. 4 and 5 illustrate a smaller version 2b of the drying device 2, which smaller version 2b comprises all of the features of the larger device 2. The utility of the smaller version 2b is that it may be used alone or in conjunction with one or more larger drying devices as required.

FIG. 6 illustrates an umbilical connector 3 8 having needled portions at opposite end portions 40 and 42 thereof for connection with one or more drying devices 2 and/or 2a and/or 2b.

Whereas the drying devices 2, 2a and 2b have been described for use on floor surfaces or the like, it will be readily appreciated that the devices may be used for drying walls and ceilings. To this end each of the drying devices 2, 2a and 2b is provided with eyelets 44 provided at spaced intervals about the peripheral edges thereof, see FIGS. 1, 2, 3, 4, 5, 7 and 8.

In order to dry a wall or ceiling a drying device 2 is hung against a wall or beneath a ceiling.

The needle fabric used herein may be ‘Velcro’ (RTM) or any other suitable means for achieving the ready attachment and detachment of the air blower 26, the collars 30 and the umbilical connectors 38 from the drying devices 2.

The material from which the sheets 4 and 6 are made is described herein as being waterproof; thus any suitable waterproof material may be used, for example plastic sheeting, rubberised canvas, rubber sheeting or the like.

Where the edge portions of the sheets are permanently co-joined, this may be achieved by stitching, gluing, heat sealing or welding dependant upon the nature of the material used for the sheets.

Likewise, the webs 16 may be co-joined between the sheets 4 and 6 by similar means.

Other modifications may be made to the drying device within the scope of the claims appended hereto, for example, the side edge portions 8 and 10 and the lower edge portion 14 may also be provided with further detachably co-joined portions similar to the mid portions 8A, 10A and 14A respectively.

1. A drying device comprising opposed sheets of flexible material cojoined along peripheral edge portions thereof wherein at least one of said sheets is provided with a multiplicity of small apertures over at least substantially its whole surface area, said drying device also comprising connector means for attachment of an air blower thereto, whereby, when said drying device is in use, air from an air blower is fed between said sheets and through said multiplicity of small apertures to remove moisture from a surface to be dried.

2. The drying device of claim 1 wherein said opposed sheets of flexible material are cojoined by a plurality of webs extending therebetween to form longitudinal channels between said sheets.

3. The drying device of claim 2 wherein said webs are each provided with perforations to facilitate, when said drying device is in use, even distribution of air from an air blower attached to the drying device.

4. The drying device of claim 1 wherein said connector means comprises edge portions of quick release material for effecting the ready attachment and detachment of an air blower thereto.

5. The drying device of claim 1 wherein said flexible material is a synthetic waterproof material.

6. The drying device of claim 5 wherein said synthetic waterproof material is plastic.

7. The drying device of claim 1 wherein said drying device comprises support means, effective when the drying device is in use, to position said drying device adjacent a wall or a ceiling to be dried.

8. The drying device of claim 1 wherein said drying device comprises a connector for co-joining one drying device with another like drying device.

9. The drying device of claim 8 wherein said connector for co-joining one drying device with another is provided by a collar of flexible material having quick release portions for ready attachment and detachment to and from each drying device.

10. The drying device of claim 1 wherein said opposed flexible sheets are at least substantially rectangular in shape.

11. A method of drying a carpet after cleaning or immersion in water comprising the steps of:
a) placing the drying device of claim 1 with a sheet having apertures therein overlying a carpet;
b) attaching an air blower to said drying device; and
c) blowing air into said drying device and through said apertures to dry said carpet.

12. A method of drying a dwelling after the ingress of water thereto comprising the steps of:
a) placing the drying device of claim 1 with at least one sheet having apertures therein against a surface, or between surfaces to be dried;
b) attaching an air blower to said drying device; and
c) blowing air into said drying device and through the apertures in said at least one sheet to dry said surface of surfaces.

13. The method of claim 12 wherein said surface to be dried is:
a) a floor; or
b) a wall; or
c) a ceiling; or
d) those surfaces bounding a closed space between floorboards and a base.

14. The method of claim 11, wherein said air is heated to above ambient temperature.

15. The method of claim 12 wherein said air is heated to above ambient temperature.

16. The method of claim 13 wherein said air is heated to above ambient temperature.
